(19) United States
(12) Patent Application Publication
(10) Pub. No.: US 2017/0232865 A1
(43) Pub. Date: Aug. 17, 2017

(54) Thermal Management System for Fast Charge Battery Electric Vehicle

(71) Applicant: Ford Global Technologies, LLC, Dearborn, MI (US)

(72) Inventors: Erik J. Christen, Royal Oak, MI (US); Matthew Fleming, Dearborn, MI (US); Raymond C. Siciak, Ann Arbor, MI (US)

(21) Appl. No.: 15/041,080

(22) Filed: Feb. 11, 2016

(51) Int. Cl. B60L 11/18; H01M 10/48; F28D 7/02; H01M 10/633; H01M 10/613; B60H 1/00; H01M 10/625; H01M 10/6556

(52) U.S. Cl. CPC B60L 11/1874; H01M 10/625; H01M 10/486; H01M 10/6556; H01M 10/633; H01M 10/613; B60H 1/00278; F28D 7/024; B60Y 2200/92; B60Y 2306/05; Y10S 903/907; H01M 2220/20

(57) ABSTRACT

An electric vehicle thermal management system may include a traction battery assembly, a coolant circuit, an exchanger, a charge port assembly, and a control system. The traction battery assembly may include a thermal plate. The coolant circuit may include a chiller and may be arranged with the thermal plate to distribute coolant thereto. The exchanger may be arranged with the coolant circuit for thermal, but not fluid, communication therebetween. The charge port assembly may be in fluid communication with the exchanger and may be configured to receive coolant from an external source. The control system may include a control line configured to communicate with the external source, to monitor conditions of the traction battery assembly, chiller, and external source, and to direct operation of the external source based on the conditions.

### TECHNICAL FIELD

The present disclosure relates to a thermal management system for an electrified vehicle such as a battery electric vehicle (“BEV”).

### BACKGROUND

Technology for electrified vehicles, such as BEVs and plug in hybrid vehicles (“PHEVs”), is continuously improving to increase their total driving distance. Achieving these increased ranges, however, often requires traction batteries with a larger capacity in comparison to previous BEVs and PHEVs. External charge stations assist in providing power to recharge traction batteries. Large capacity traction batteries often require longer charge times, and fast charge events may drive battery thermal conditions outside desired ranges.

### SUMMARY

An electric vehicle thermal management system includes a traction battery assembly, a coolant circuit, an exchanger, a charge port assembly, and a control system. The traction battery assembly has a thermal plate. The coolant circuit includes a chiller and is arranged with the thermal plate to distribute coolant thereto. The exchanger is arranged with the coolant circuit for thermal, but not fluid, communication therebetween. The charge port assembly is in fluid communication with the exchanger and is configured to receive coolant from an external source. The control system includes a control line configured to communicate with the external source, to monitor conditions of the traction battery assembly, chiller, and external source, and to direct operation of the external source based on the conditions. The charge port assembly may define an inlet channel to deliver coolant from the external source to a coolant circuit of the exchanger and an outlet channel to deliver coolant to the external source. The control system may be further configured to direct the external source to deliver a predetermined amount of coolant to the exchanger based on a measured temperature of the thermal plate. The exchanger may be wound about a portion of the coolant circuit at a spacing therefrom sized to receive a thermal interface material. The coolant circuit may further include a pipe and the exchanger may be disposed about at least a portion of the pipe. The exchanger and coolant circuit may be further arranged with one another such that coolant flowing from the external source does not mix with coolant flowing within the coolant circuit. The system may include a first sensor to measure a temperature of coolant from the chiller, a second sensor to measure temperature of coolant from the external source, and a third sensor to measure temperature of coolant of the thermal plate. The sensors may be in electrical communication with the control system to deliver signals including the measured temperatures thereto. The control system may be further configured to direct the external source to transfer a predetermined amount of coolant at a predetermined temperature to the exchanger based on the measured temperatures.

An electric vehicle includes a traction battery, a chiller, a charge port, a heat exchanger, sensors, and a battery control module. The traction battery assembly includes a thermal plate. The chiller is in fluid communication with the thermal plate via a coolant circuit channel. The charge port assembly defines two coolant channels each configured for fluid communication with an external charge station. The heat exchanger is arranged with the coolant circuit channel for thermal communication therebetween. The sensors measure a temperature of a coolant of the chiller, the exchanger, and the thermal plate. The battery control module receives the measured temperatures and directs operation of the charge station based on whether the measured temperatures fall within respective predetermined temperature ranges. The exchanger is not in fluid communication with the thermal plate. The thermal plate may only receive coolant via the coolant circuit channel. The electric vehicle may further include a thermal interface layer disposed between the heat exchanger and coolant circuit channel. The heat exchanger may include an exchanger coolant channel in fluid communication with the charge port assembly. At least a portion of the exchanger coolant channel may be spaced apart from and wound about the coolant circuit channel. The exchanger coolant channel may be spaced apart from the coolant circuit channel at a distance sized to receive a thermal interface material. The battery control module may be configured to activate disbursement of coolant of the charge station in response to detection of a charge event.

A thermal management method for an electric vehicle outputs, via a controller, a control strategy to direct operation of a charge station remote from the vehicle to selectively output coolant to a vehicle exchanger without the coolant entering a thermal plate of a vehicle traction battery assembly in response to receiving a predetermined combination of temperature values of coolant for each of a vehicle chiller, the vehicle exchanger, and the thermal plate. The method may further include exchanging heat between the exchanger and chiller via a portion of a coolant circuit including the chiller in which the exchanger and chiller are in thermal communication with each other via a thermal interface material disposed therebetween and without being in fluid communication with each other. The method may further include outing a deactivation signal to a coolant disbursement assembly of the charge station to cease coolant output by the charge station. The method may further include outputting an activation signal to a coolant disbursement assembly of the charge station in response to detection of a charge event. The method may further include outputting an activation signal to a coolant disbursement assembly of the charge station based on a predetermined temperature value of the coolant of the thermal plate.

### BRIEF DESCRIPTION OF THE DRAWINGS

FIG. 1 is a schematic illustrating an example of an electrified vehicle.

FIG. 2 is a schematic illustrating an example of a portion of a thermal management system for a battery electric vehicle.

FIG. 3A is a front view of a portion of the thermal management system of FIG. 2.

FIG. 3B is a side view of the portion of the thermal management system of FIG. 3A.

FIG. 4 shows a flow chart depicting an example of operation of a control system of the thermal management system of FIG. 2.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

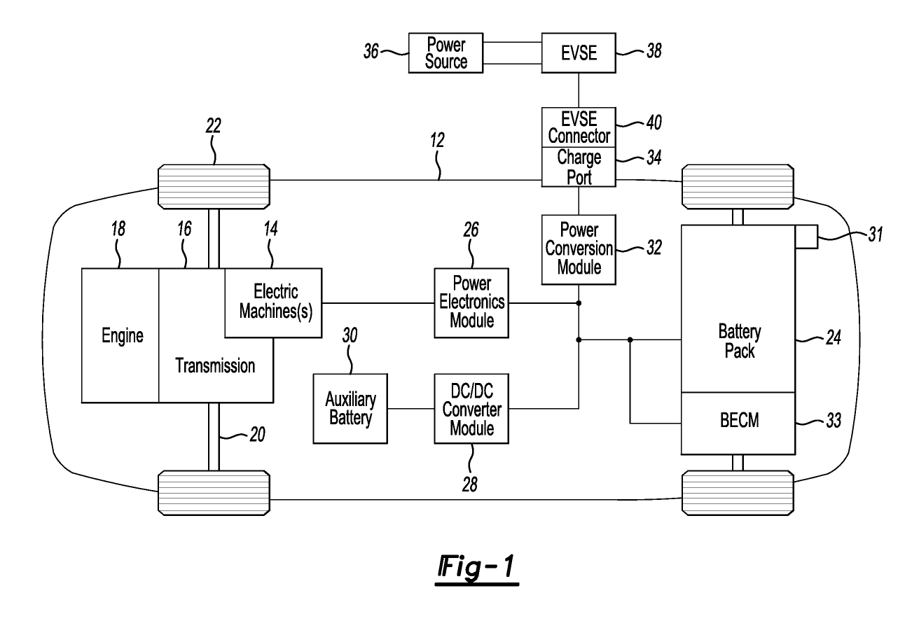

FIG. 1 depicts a schematic of an example of a PHEV, referred to as a vehicle 12 herein. The vehicle 12 may comprise one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off. The electric machines 14 may also act as generators and may provide fuel economy benefits by recovering energy that would normally be lost as heat in the friction braking system. The electric machines 14 may also provide reduced pollutant emissions since the hybrid-electric vehicle 12 may be operated in electric mode or hybrid mode under certain conditions to reduce overall fuel consumption of the vehicle 12.

A traction battery or battery pack 24 stores and provides energy that may be used by the electric machines 14. The traction battery 24 may provide a high voltage DC output from one or more battery cell arrays, sometimes referred to as battery cell stacks, within the traction battery 24. The battery cell arrays may include one or more battery cells. The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may also be electrically connected to the electric machines 14 and provides the ability to bi-directionally transfer electrical energy between the traction battery 24 and the electric machines 14. For example, the traction battery 24 may provide a DC voltage while the electric machines 14 may require a three-phase AC voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. Portions of the description herein are equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A DC/DC converter module 28 may convert high voltage DC output of the traction battery 24 to a low voltage DC supply that is compatible with other vehicle loads. Other high-voltage loads, such as compressors and electric heaters, may be connected directly to the high-voltage without the use of the DC/DC converter module 28. The low-voltage systems may be electrically connected to an auxiliary battery 30 (e.g., 12V battery).

A battery electrical control module (“BECM”) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24. The temperature sensor 31 may also be located on or near the battery cells within the traction battery 24. It is also contemplated that more than one temperature sensor 31 may be used to monitor temperature of the battery cells.

The vehicle 12 may be, for example, an electrified vehicle that includes components for a PHEV, a FHEV, a MHEV, or a BEV. The traction battery 24 may be recharged by an external power source 36. The external power source 36 may be a connection to an electrical outlet. The external power source 36 may be electrically connected to electric vehicle supply equipment (“EVSE”) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus (e.g., Controller Area Network (“CAN”)) or via discrete conductors.

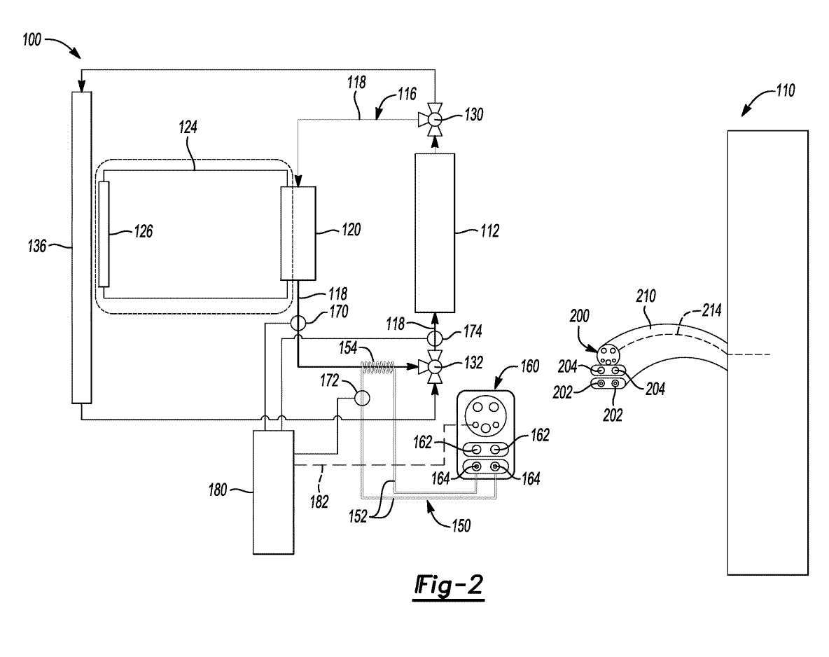

FIG. 2 shows an example of a schematic for a thermal management system for a vehicle and a charge station, referred to generally as a thermal management system 100 and a charge station 110, respectively. The charge station 110 may include a reservoir (not shown) to store fluid, such as coolant, for exchanging with external devices or systems. The thermal management system 100 may assist in managing conditions of a traction battery assembly 112 of an electric vehicle such as a PHEV. For example, the conditions may include a temperature or thermal condition of one or more components of the traction battery assembly 112. The traction battery assembly 112 may include an array of battery cells and a thermal plate, such as a cold plate. The thermal plate may be located proximate the battery cells and include a flow field for coolant to flow therethrough. Coolant flowing through the flow field may assist in managing a temperature of the battery cell array in a cooling or heating capacity.

The thermal management system 100 may include a coolant circuit 116. The coolant circuit 116 may include channels or pipes, such as channels 118 to provide fluid communication between components of the coolant circuit 116. For example, the coolant circuit 116 may direct fluid through a chiller 120 and the thermal plate of the traction battery assembly 112. The chiller 120 may be a part of an AC system 124 which may also include an AC condenser 126. A first valve 130 and a second valve 132 may assist in directing coolant throughout the coolant circuit 116 and optionally to a radiator 136.

The thermal management system 100 may include an exchanger circuit 150. The exchanger circuit 150 may include coolant lines 152 and an exchanger 154. The exchanger 154 may be disposed about and spaced apart from a portion of the coolant circuit 116. For example, a thermal interface material (“TIM”) may be located therebetween to assist in enhancing a transfer of heat. A charge port assembly 160 may be onboard the vehicle and in fluid communication with the exchanger circuit 150. The charge port assembly 160 may include one or more electrical charge ports 162 and one or more fluid exchange ports 164. A plurality of sensors may be disposed throughout the thermal management system 100 to assist in monitoring thermal conditions thereof. For example, the thermal management system may include a first sensor 170, a second sensor 172, and a third sensor 174.

The first sensor 170 may monitor thermal conditions, such as temperature, of components and fluids of the traction battery assembly 112. For example, a temperature of coolant flowing through the thermal plate of the traction battery assembly 112 may be measured by the first sensor 170 at various positions within the traction battery assembly 112 and proximate thereto. The second sensor 172 may monitor thermal conditions, such as temperature, of fluids and components of the exchanger circuit 150. For example, a temperature of coolant flowing through the exchanger 154 may be measured by the second sensor 172 at various positions within the exchanger circuit 150 and proximate thereto. The third sensor 174 may monitor thermal conditions, such as temperature, of fluids and components of the coolant circuit 116. For example, a temperature of coolant flowing through the chiller 120 may be measured at various positions within the chiller 120 and proximate thereto.

The electrical charge ports 162 may assist in facilitating electrical communication with the charge station 110. For example, the thermal management system may include a controller, such as a battery control module 180. The battery control module 180 may assist in directing operation of the thermal management system 100. For example, the battery control module 180 may monitor sensors of the thermal management system 100 and direct operation of other components therein to provide desirable thermal conditions throughout the thermal management system 100. Detection of a charge event by the battery control module 180 may prompt a response in which the battery control module 180 directs components to adjust coolant flow to maintain desirable conditions of the traction battery assembly 112. The battery control module 180 may also be electrically connected to external devices via the electrical charge ports 162 to direct operation thereof, such as the charge station 110 as further described herein.

The fluid exchange ports 164 may be open to the coolant lines 152 to assist in transferring coolant from an external source, such as the charge station 110. For example, the charge station 110 may include a charge station outlet assembly 200. The outlet assembly 200 may include coolant outlet ports 202 and electrical ports 204. The coolant outlet ports 202 and the fluid exchange ports 164 may be sized for operable connection to assist in facilitating fluid communication between the exchanger circuit 150 and the reservoir of the charge station 110. A charge station cable 210 may extend from the charge station 110 to assist in operably connecting the charge station 110 to external devices, such as the thermal management system 100. A control line 214 may extend through the charge station cable 210 and be in electrical communication with a controller (not shown) of the charge station 110 to assist in facilitating communication between, in this example, the battery control module 180 and the charge station 110. Under certain circumstances, such as a charge event, the battery control module 180 may direct operations of the thermal management system 100 and the charge station 110.

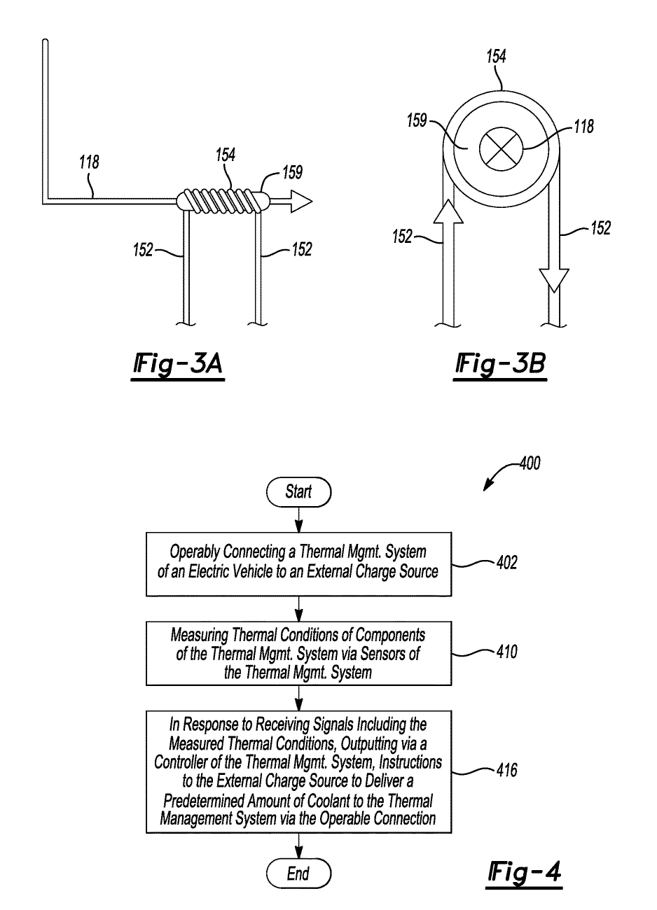

FIGS. 3A and 3B show an example of a portion of a thermal management system for an electric vehicle, such as the thermal management system 100. The exchanger 154 may have various suitable configurations and orientations relative to the coolant circuit 116. For example, the exchanger 154 may be structurally separated and spaced apart from the channel 118 of the coolant circuit 116. The spacing may be sized to receive a thermal interface material to assist in enhancing heat transfer. For example, a thermal interface material, such as a TIM 159 may be disposed between the coolant channel 118 and the exchanger 154. A combination of the exchanger 154, the coolant circuit 116, and the TIM 159 may be collectively referred to as a fast charge chiller. During operation, the fast charge chiller may assist in removing heat from the coolant circuit 116 when coolant flows from the charge station 110 without coolant of the charge station 110 entering the thermal plate of the traction battery assembly 112.

FIG. 4 shows an example of a method of operating a thermal management system and an external charge source to assist in managing conditions of a thermal plate of a traction battery assembly, referred to generally as an operation 400 herein. For example, a controller, such as the battery control module 180 as described above, may detect a charge event and operate to maintain thermal conditions of a traction battery assembly, such as the traction battery 112 described above. In operation 402, a thermal management system of an electric vehicle may be operably connected to an external charge source for fluid communication and electrical communication. For example, the thermal management system may be in fluid communication and electrical communication with a charge port assembly onboard the vehicle. The external charge source may include a reservoir for storing fluid, such as a coolant. The external charge source may have components to facilitate distribution of the coolant to the thermal management system of the vehicle via the charge port assembly and to facilitate fluid communication therebetween such that coolant may be delivered to at least a portion of the thermal management system from the external charge source assist in managing thermal conditions thereof.

For example, the coolant may be delivered to an exchanger in thermal communication with a coolant circuit. In this example, the exchanger does not pass any coolant from the external charge source to the coolant circuit. Rather, the exchanger is located proximate a portion of the coolant circuit to facilitate the thermal communication. For example, the exchanger may be wound about the portion of the coolant circuit and spaced apart therefrom at a suitable distance. The portion of the coolant circuit in thermal communication with the exchanger may be in fluid communication with the thermal plate of the traction battery assembly such that the coolant from the external charge source may assist in managing conditions of the traction battery.

In operation 410, sensors may measure thermal conditions of components of the thermal management system. For example, sensors may be positioned within the thermal management system to measure temperatures of coolant within a chiller of the coolant circuit and coolant within the thermal plate of the traction battery assembly. A sensor may be included in the thermal management system to measure a temperature of coolant flowing at or near the exchanger. The measured temperatures may be sent to a controller of the thermal management system. For example, the sensors may be in electrical communication with the controller such that the measured temperatures may be sent as, for example, digital signals.

The controller may also be in electrical communication with the external charge source via the charge port assembly and such that the controller may direct operation of the external charge source. For example, in operation 416 the controller may send instructions to the external charge source in response to receipt of the signals including the measured temperatures. The instructions may direct the external charge station to output a predetermined amount of coolant based on the measured temperatures. A charge event is one example of a scenario in which thermal conditions of the traction battery may arise at values outside of a predetermined range of suitable vehicle operation conditions. The controller may thus direct the charge station to output coolant to assist in managing thermal conditions of the traction battery assembly without coolant of the charge station entering the thermal plate of the traction battery assembly.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electric vehicle thermal management system comprising:
a traction battery assembly having a thermal plate;
a coolant circuit, including a chiller, arranged with the thermal plate to distribute coolant thereto;
an exchanger arranged with the coolant circuit for thermal, but not fluid, communication therebetween;
a charge port assembly in fluid communication with the exchanger and configured to receive coolant from an external source; and
a control system including a control line configured to communicate with the external source, to monitor conditions of the traction battery assembly, chiller, and external source, and to direct operation of the external source based on the conditions.

2. The system of claim 1, wherein the charge port assembly defines an inlet channel to deliver coolant from the external source to a coolant circuit of the exchanger and an outlet channel to deliver coolant to the external source.

3. The system of claim 2, wherein the control system is further configured to direct the external source to deliver a predetermined amount of coolant to the exchanger based on a measured temperature of the thermal plate.

4. The system of claim 1, wherein the exchanger is wound about a portion of the coolant circuit and at a spacing therefrom sized to receive a thermal interface material.

5. The system of claim 1, wherein the coolant circuit further includes a pipe and wherein the exchanger is disposed about at least a portion of the pipe.

6. The system of claim 1, wherein the exchanger and coolant circuit are further arranged with one another such that coolant flowing from the external source does not mix with coolant flowing within the coolant circuit.

7. The system of claim 1 further comprising a first sensor to measure a temperature of coolant from the chiller, a second sensor to measure temperature of coolant from the external source, and a third sensor to measure temperature of coolant of the thermal plate, wherein the sensors are in electrical communication with the control system to deliver signals including the measured temperatures thereto.

8. The system of claim 7, wherein the control system is further configured to direct the external source to transfer a predetermined amount of coolant at a predetermined temperature to the exchanger based on the measured temperatures.

9. An electric vehicle comprising:
a traction battery assembly including a thermal plate;
a chiller in fluid communication with the thermal plate via a coolant circuit channel;
a charge port assembly defining two coolant channels each configured for fluid communication with an external charge station;
a heat exchanger arranged with the coolant circuit channel for thermal communication therebetween;
sensors to measure a temperature of a coolant of the chiller, the exchanger, and the thermal plate; and
a battery control module to receive the measured temperatures and direct operation of the charge station based on whether the measured temperatures fall within respective predetermined temperature ranges.

10. The vehicle of claim 9, wherein the exchanger is not in fluid communication with the thermal plate.

11. The vehicle of claim 9, wherein the thermal plate only receives coolant via the coolant circuit channel.

12. The vehicle of claim 9, further comprising a thermal interface layer disposed between the heat exchanger and coolant circuit channel.

13. The vehicle of claim 9, wherein the heat exchanger comprises an exchanger coolant channel in fluid communication with the charge port assembly, and wherein at least a portion of the exchanger coolant channel is spaced apart from and wound about the coolant circuit channel.

14. The vehicle of claim 13, wherein the exchanger coolant channel is spaced apart from the coolant circuit channel at a distance sized to receive a thermal interface material.

15. The vehicle of claim 9, wherein the battery control module is configured to activate disbursement of coolant of the charge station in response to detection of a charge event.

16. A thermal management method for an electric vehicle comprising:
in response to receiving a predetermined combination of temperature values of coolant for each of a vehicle chiller, a vehicle exchanger, and a thermal plate of a vehicle traction battery assembly, outputting via a controller a control strategy to direct operation of a charge station remote from the vehicle to selectively output coolant to the vehicle exchanger without the coolant entering the thermal plate.

17. The method of claim 16, further comprising exchanging heat between the exchanger and chiller via a portion of a coolant circuit including the chiller in which the exchanger and chiller are in thermal communication with each other via a thermal interface material disposed therebetween and without being in fluid communication with each other.

18. The method of claim 16, further comprising outputting a deactivation signal to a coolant disbursement assembly of the charge station to cease coolant output by the charge station.

19. The method of claim 16, further comprising outputting an activation signal to a coolant disbursement assembly of the charge station in response to detection of a charge event.

20. The method of claim 16, further comprising outputting an activation signal to a coolant disbursement assembly of the charge station based on a predetermined temperature value of the coolant of the thermal plate.
